(19) United States
(12) Patent Application Publication
(10) Pub. No.: US 2025/0196238 A1
(43) Pub. Date: Jun. 19, 2025

(54) CIRCULAR SAW

(71) Applicant: MAKITA CORPORATION, ANJO-SHI (JP)

(72) Inventors: Hirotomo INAYOSHI, Anjo-shi (JP); Tomoki SHIRAI, Anjo-shi (JP); Kenji HAMADA, Anjo-shi (JP)

(21) Appl. No.: 18/944,264

(22) Filed: Nov. 12, 2024

(30) Foreign Application Priority Data
Dec. 13, 2023 (JP) 2023-210299
Jun. 13, 2024 (JP) 2024-096055

(51) Int. Cl. B23D 45/16; B25F 5/02

(52) U.S. Cl. CPC B23D 45/16; B25F 5/026

(57) ABSTRACT

A circular saw includes: a rotatable circular-saw blade; an electric motor that generates rotational power for rotatably driving the circular-saw blade; and a battery-mounting part configured to detachably mount a battery that supplies electric power to the electric motor. The diameter of the circular-saw blade is 300 mm or more and 460 mm or less.

### CROSS-REFERENCE

The present application claims priority to Japanese patent application no. 2023-210299 filed on Dec. 13, 2023, and to Japanese patent application serial number 2024-096055 filed Jun. 13, 2024, the contents of which are incorporated herein by reference.

### TECHNICAL FIELD

The present invention relates to a circular saw.

### BACKGROUND ART

A cutting machine known as a portable circular saw (hereinbelow, simply called a circular saw) comprises a base and a main-body portion. The main-body portion comprises a circular-saw blade, which is rotationally driven by an electric motor. The main-body portion is disposed on one side relative to the base, and a portion of the circular-saw blade protrudes on the other side beyond the base; i.e. a lower portion of the circular-saw blade protrudes through the base to cut workpieces. When using such a circular saw, a user brings a lower surface of the base into contact with a workpiece in the state in which the circular-saw blade is rotating, and moves the cutting machine forward. Thereby, the circular-saw blade, which protrudes beyond (below) the base, cuts the workpiece. Japanese Laid-open Patent Publication 2020-116834 discloses, as one type of such a circular saw, a portable circular saw that uses a battery as the electric-power supply of the electric motor.

### SUMMARY OF THE INVENTION

In the past, in a circular saw that uses a battery as an electric-power supply, such as in Patent Document 1, the diameter of the circular-saw blade was relatively small (e.g., a diameter of 125 mm) and thus cutting efficiency was poor, in particular, for thicker workpieces. This problem, which is not limited to portable circular saws, is common to circular saws that are used by being installed in a fixed manner on a work stand. In view of the foregoing, it is desired to improve the cutting efficiency of circular saws that use a battery as the electric-power supply.

In one non-limiting aspect of the present teachings, a circular saw may comprise: a rotatable circular-saw blade; an electric motor for providing rotational driving power to the circular-saw blade; and a battery-mounting part, which is configured to detachably mount a battery for supplying electric power to the electric motor. The diameter of the circular-saw blade may be 300 mm or more and 460 mm or less, i.e. from 300 to 460 mm.

According to this circular saw, because the diameter of the circular-saw blade is 300 mm or more and 460 mm or less, the radius of curvature of the circular-saw blade is large (the curvature is small) compared with known cordless (battery-type) circular saws equipped with a small-diameter circular-saw blade. Accordingly, even if a workpiece has a large (thick) cross section, cutting can be performed efficiently.

In another non-limiting aspect of the present teachings, a circular saw may comprise: a rotatable circular-saw blade; an electric motor for providing rotational driving power to the circular-saw blade; a rotatable final output shaft, on which the circular-saw blade is mounted and to which the rotational driving power of the electric motor is transmitted; and a battery-mounting part, which is configured to detachably mount a battery for supplying electric power to the electric motor. When the torque of the final output shaft is 5 N/m, the value resulting from multiplying the circumferential speed of a blade edge of the circular-saw blade by the diameter of the circular-saw blade may be 6.0 m²/s or more.

According to this circular saw, even if the workpiece has a large (thick) cross section, the circular-saw blade, which has a sufficient diameter, can cut the workpiece efficiently because it is rotated at a sufficient circumferential speed.

### BRIEF DESCRIPTION OF THE DRAWINGS

FIG. 1 is an oblique view of a circular saw according to one embodiment of the present invention.

FIG. 2 is an oblique view of the circular saw.

FIG. 3 is an oblique view of the circular saw, in which a battery has been removed.

FIG. 4 is a front view of the circular saw, in which some component parts have been removed.

FIG. 5 is a left view that shows a first example of dimensions of the circular saw.

FIG. 6 is a plan view that shows the first example of the dimensions of the circular saw.

FIG. 7 is a left view that shows a second example of the dimensions of the circular saw.

FIG. 8 is a plan view that shows the second example of the dimensions of the circular saw.

FIG. 9 is a left view that shows a third example of the dimensions of the circular saw.

FIG. 10 is a plan view that shows the third example of the dimensions of the circular saw.

FIG. 11 is a left view of the circular saw according to a second embodiment.

FIG. 12 is a right view of the circular saw according to the second embodiment.

FIG. 13 is a plan view of the circular saw according to the second embodiment.

FIG. 14 is a bottom view of the circular saw according to the second embodiment.

FIG. 15 is a front view of the circular saw according to the second embodiment.

FIG. 16 is a rear view of the circular saw according to the second embodiment.

FIG. 17 is a graph that shows the relationship between the torque of a final output shaft and the product of the circumferential speed of a blade edge and a diameter of a circular-saw blade.

FIG. 18 is a plan view of the circular saw according to a third embodiment.

### DETAILED DESCRIPTION OF THE INVENTION

Representative and non-limiting concrete examples of the present invention are explained below in detail, with reference to the drawings. This detailed description is merely intended to disclose to a person skilled in the art details for implementing preferable examples of the present invention and is not intended to limit the scope of the present invention. In addition, supplementary features and inventions disclosed below can be employed separately from or together with other features or inventions to provide further improved devices, as well as manufacturing methods and methods of use therefor.

In addition, combinations of features or processes disclosed in the detailed description below are not required when implementing the present invention in the broadest possible sense and are described only for explaining representative concrete examples of the present invention in particular. Moreover, when providing additional, useful embodiments of the present invention, various features of the above-mentioned and below-mentioned representative concrete examples as well as various features that are described in the independent and dependent claims need not be as described in the concrete examples recited herein nor combined in the order enumerated.

Separately from the configurations of the features described in the embodiments and/or the claims, all the features described in the present specification and/or the claims are intended to be disclosed individually and mutually independently as limitations on the specific matters disclosed and claimed at the time of filing. Moreover, the descriptions of all numerical ranges and groupings or categories are intended to disclose all intermediate configurations thereof as limitations on the specific matters disclosed and claimed at the time of filing.

In one or more embodiments, a circular saw may be configured so that a circular-saw blade rotates at a circumferential speed of 70.0 m/s or less under no-load. According to this configuration, the difference between the circumferential speeds of the circular-saw blade under no-load and under a load can be made relatively small. Accordingly, the behavior of the circular saw when starting to cut the workpiece is stable. As a result, the user's experience can be improved and the cut surface of the workpiece also can be made flatter.

In one or more embodiments, the circular saw may be configured so that the circular-saw blade rotates at a circumferential speed of 50.0 m/s or less under no-load. According to this configuration, the difference between the circumferential speeds of the circular-saw blade under no-load and under a load can be made relatively small. Accordingly, the behavior of the circular saw when starting to cut the workpiece is even more stable.

In one or more embodiments, the circular saw may be configured so that the circular-saw blade rotates at a circumferential speed of 25.0 m/s or more under a load. According to this configuration, even if the workpiece has a large (thick) cross section, cutting can be efficiently performed at a sufficient circumferential speed.

In one or more embodiments, the circular saw may be configured so that the circular-saw blade rotates at a circumferential speed of 28.0 m/s or more under a load. According to this configuration, the workpiece can be cut more efficiently.

In one or more embodiments, the circular saw may be configured to rotate so that the force at a blade edge of the circular-saw blade under a load becomes 20.0 N or more. The “force at the blade edge” is the force that the blade edge applies to the cutting location (site) of the workpiece. According to this configuration, even if the workpiece has a large (thick) cross section, the workpiece can be cut efficiently because a sufficient cutting force acts on the workpiece.

In one or more embodiments, the circular saw may be configured to rotate so that the force at the blade edge of the circular-saw blade under a load becomes 30.0 N or more. According to this configuration, the workpiece can be cut more efficiently.

In one or more embodiments, the circular saw may comprise a battery that supplies electric power to drive the electric motor. The rated voltage of the battery may be 18 V or more and 80 V or less. According to this configuration, even if the workpiece has a large (thick) cross section, the workpiece can be cut efficiently owing to sufficient battery output.

In one or more embodiments, the rated voltage of the battery may be 36 V. According to this configuration, the circular saw can be designed to be, with satisfactory balance, both compact (as well as, e.g., being lightweight) and capable of delivering high output power.

In one or more embodiments, the circular saw may comprise a speed-reducing mechanism configured to transmit the rotational driving power of the electric motor at a lower rotational speed to the circular-saw blade. The speed-reduction ratio (also known as “speed ratio” or “angular speed ratio”) of the speed-reducing mechanism may be 7 or more (or alternatively expressed, 7:1 or more). According to this configuration, even if the workpiece has a large (thick) cross section, the workpiece can be cut efficiently because the speed-reducing mechanism supplies sufficient torque to the circular-saw blade.

In one or more embodiments, the circular saw may be a portable circular saw. The portable circular saw may comprise: a first handle, which has a first grip part; and a second handle, which has a second grip part and is disposed more forward than the first handle when the direction in which cutting by the portable circular saw is advanced is defined as a front side, and the opposite side to the front side is defined as a rear side. The battery-mounting part may be configured so that, when the battery is mounted on the battery-mounting part, the entire battery is located between an end portion at the front side of the first grip part and an end portion at the front side of the second grip part in a front-rear direction. According to this configuration, because the battery, which is a heavy object, is located between the end portion at the front side of the first grip part and the end portion at the front side of the second grip part, the weight balance is improved when the user grips the first grip part and the second grip part and holds the portable circular saw, regardless of whether the portable circular saw has a large-diameter circular-saw blade (e.g., a circular-saw blade of a diameter of 300 mm or more). Accordingly, the user can hold the portable circular saw stably with a smaller force; i.e. it is less tiring (burdensome) to operate the circular saw.

In one or more embodiments, the circular saw may be a portable circular saw. The portable circular saw may comprise: a first handle, which has a first grip part; and a second handle, which has a second grip part and is disposed more forward than the first handle when the direction in which cutting by the portable circular saw is advanced is defined as the front side, and the opposite side to the front side is defined as the rear side. The center of gravity of the circular saw, in the state in which the battery is mounted on the battery-mounting part, may be located more downward than an end portion at the lower side of the first grip part and an end portion at the lower side of the second grip part in an up-down direction in the posture of the portable circular saw during normal usage thereof. According to this configuration, the user can hold the portable circular saw stably with a smaller force when the user grips the first grip part and the second grip part and holds the portable circular saw.

In one or more embodiments, the circular saw may be a portable circular saw. The portable circular saw may comprise: a first handle, which has a first grip part; and a second handle, which has a second grip part and is disposed more forward than the first handle when the direction in which cutting by the portable circular saw is advanced is defined as the front side, and the opposite side to the front side is defined as the rear side; and the battery (i.e. rechargeable battery pack or cartridge). The center of gravity of the battery, in the state in which the battery is mounted on the battery-mounting part, may be located more downward than an end portion at the lower side of the first grip part and an end portion at the lower side of the second grip part in an up-down direction in the posture of the portable circular saw during normal usage thereof. Because the center of gravity of the battery, which is a heavy object, is located more downward than the grip parts, i.e., the first grip part and the second grip part, the user can hold the portable circular saw stably with a smaller force when the user grips the first grip part and the second grip part and holds the portable circular saw.

In one or more embodiments, the circular saw may be a portable circular saw. The portable circular saw may comprise: a first handle, which has a first grip part; and a second handle, which has a second grip part and is disposed more forward than the first handle when the direction in which cutting by the portable circular saw is advanced is defined as the front side, and the opposite side to the front side is defined as the rear side. In the front-rear direction, when a distance between a first center point of the first grip part, which is the center point of an area where the user actually grips the first grip part, and a second center point, which is the center point of the second grip part, is given as L1, and a distance between the first center point and a first center of gravity, which is the center of gravity of the circular saw in the state in which the battery is mounted on the battery-mounting part, is given as L2, the value of L2/L1 may be 0.5 or more and 0.7 or less. According to this configuration, the weight balance is improved when the user grips the first grip part and the second grip part and holds the portable circular saw, regardless of whether the portable circular saw has a large-diameter circular-saw blade (e.g., a circular-saw blade of a diameter of 300 mm or more). Accordingly, the user can hold the portable circular saw stably with a smaller force.

In one or more embodiments, in the up-down direction in the posture of the portable circular saw during normal usage thereof, when a distance between the first center point of the first grip part, which is the center point of an area where the user actually grips the first grip part, and the second center point, which is the center point of the second grip part, is given as L3, and a distance between the first center point and the first center of gravity, which is the center of gravity of the circular saw in the state in which the battery is mounted on the battery-mounting part, is given as L4, the value of L4/L3 may be 3.4 or more and 3.8 or less. According to this configuration, the weight balance is improved for the user when the user grips the first grip part and the second grip part and holds the portable circular saw.

In one or more embodiments, in the front-rear direction, when a distance between the first center point of the first grip part, which is the center point of an area where the user actually grips the first grip part, and the second center point, which is the center point of the second grip part, is given as L1, and a distance between the first center point and a second center of gravity, which is the center of gravity of the battery in the state in which the battery is mounted on the battery-mounting part, is given as L5, the value of L5/L1 may be 0.1 or more and 0.3 or less. According to this configuration, the weight balance is improved for the user when the user grips the first grip part and the second grip part and holds the portable circular saw.

In one or more embodiments, in the up-down direction in the posture of the portable circular saw during normal usage thereof, when a distance between the first center point of the first grip part, which is the center point of an area where the user actually grips the first grip part, and the second center point, which is the center point of the second grip part, is given as L3, and a distance between the first center point and the second center of gravity, which is the center of gravity of the battery in the state in which the battery is mounted on the battery-mounting part, is given as L6, the value of L6/L3 may be 2.8 or more and 3.2 or less. According to this configuration, the weight balance is improved for the user when the user grips the first grip part and the second grip part and holds the portable circular saw.

In one or more embodiments, in an axial direction, which is the direction in which the rotational axis of the circular-saw blade extends, when a distance between the first center point of the first grip part, which is the center point of an area where the user actually grips the first grip part, and the second center point, which is the center point of the second grip part, is given as L7, and a distance between the first center point and the first center of gravity, which is the center of gravity of the circular saw in the state in which the battery is mounted on the battery-mounting part, is given as L8, the value of L8/L7 may be 0.4 or more and 0.7 or less. According to this configuration, the weight balance is improved for the user when the user grips the first grip part and the second grip part and holds the portable circular saw.

In one or more embodiments, in the axial direction, which is the direction in which the rotational axis of the circular-saw blade extends, when a distance between the first center point of the first grip part, which is the center point of an area where the user actually grips the first grip part, and the second center point, which is the center point of the second grip part, is given as L7, and a distance between the first center point and the second center of gravity, which is the center of gravity of the battery in the state in which the battery is mounted on the battery-mounting part, is given as L9, the value of L9/L7 may be 1.3 or more and 1.5 or less. According to this configuration, the weight balance is improved for the user when the user grips the first grip part and the second grip part and holds the portable circular saw.

In one or more embodiments, the circular saw may be a portable circular saw and may comprise a base having a through hole (slot) through which the circular-saw blade can pass. When the side on which the electric motor is located relative to the base is defined as the upper side, and the opposite side thereto is defined as the lower side, the circular-saw blade is orthogonal to the base and, in the state in which a protrusion distance that the circular-saw blade passes through the through hole and protrudes downward relative to the base (i.e. the amount of the circular-saw blade that extends below the base) becomes (is) a maximum, the protrusion distance may be 100 mm or more (i.e. 100 mm or more of the circular-saw blade (i.e. of the distance from the rotational center of the circular-saw blade to the circumferential edge thereof) may protrude below the base). According to this configuration, compared with existing circular saws, workpieces having a larger thickness can be cut.

In one or more embodiments, in the state in which the circular-saw blade is orthogonal to the base and the protrusion distance that the circular-saw blade passes through the through hole and protrudes downward relative to the base (i.e. the amount of the circular-saw blade that extends below the base) becomes (is) the maximum, the protrusion distance at the lower side of the circular-saw blade may be 150 mm or more (i.e. 150 mm or more of the circular-saw blade (i.e. of the distance from the rotational center of the circular-saw blade to the circumferential edge thereof) may protrude below the base). According to this configuration, a workpiece having an even larger thickness can be cut.

When the torque of the final output shaft is 5 N/m, the value resulting from multiplying the circumferential speed of the blade edge of the circular-saw blade by the diameter of the circular-saw blade may be 10.0 m²/s or more. According to this configuration, a circular-saw blade, which has a sufficient diameter, can cut the workpiece even more efficiently because it rotates at a sufficient circumferential speed to cut even relatively thick workpieces.

In one or more embodiments, the circular saw may be a portable circular saw and may comprise a base having a through hole (slot) through which the circular-saw blade can pass. When the side toward which the circular saw is advanced when the circular saw is cutting a workpiece is defined as the front side, the opposite side thereof is defined as the rear side, the side on which the electric motor is located relative to the base is defined as the upper side, and the opposite side thereof is defined as the lower side, a direction orthogonal to a front-rear direction and an up-down direction is defined as a left-right direction, and the right side when looking from the rear side to the front side is defined as the right side, and the opposite side thereof is defined as the left side, the circular-saw blade may be located on the left side relative to the electric motor. According to this configuration, when a user uses the circular saw while standing on the left side of the circular saw, the electric motor is not positioned in the user's line of sight to the circular-saw blade. As a result, when the user is performing work using the circular saw, the visibility of the circular-saw blade, which is visible between a front portion of a fixed cover and a front portion of the base, can be improved, particularly at a site where the circular-saw blade intersects (is cutting into) a marking line on the workpiece.

In one or more embodiments, the circular saw may comprise: a first handle, which has a first grip part that is located, at least partially, more rearward than the circular-saw blade in the front-rear direction; a second handle, which has a second grip part that is located more forward than the electric motor in the front-rear direction and located more rightward than the circular-saw blade in the left-right direction; and a third handle, which has a third grip part that is located more leftward than the circular-saw blade in the left-right direction. According to this configuration, the user can choose to use the different handles that are to be gripped in accordance with the user's working posture. For example, the user may grip the first grip part with one hand and the second grip part with the other hand to use the circular saw. Alternatively, the user may grip the first grip part with one hand and the third grip part with the other hand to use the circular saw. Moreover, because the spacing in the front-rear direction between the first grip part and the second grip part can be made relatively large, the user can hold the circular saw more stably when the user grips the first grip part and the second grip part to use the circular saw.

In one or more embodiments, the third grip part may be located more forward than the electric motor in the front-rear direction. According to this configuration, because the spacing in the front-rear direction between the first grip part and the third grip part can be made larger, the user can hold the circular saw more stably when the user grips the first grip part with one hand and the third grip part with the other hands to use the circular saw.

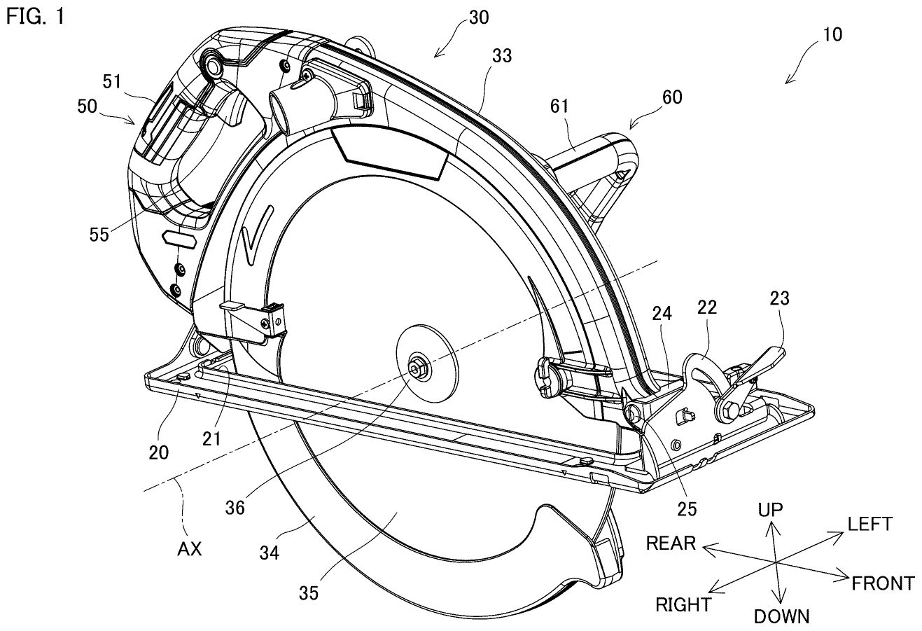

A portable circular saw (hereinbelow, simply called a circular saw) 10 according to an exemplary embodiment will be explained in detail below with reference to FIGS. 1-6. In the explanation below, when the user holds the circular saw 10 with two hands to cut a workpiece (in other words, when the circular saw is in the normal posture for a cutting operation), the side toward which the circular saw 10 is advanced (the side toward which cutting by a circular-saw blade 35, described below, is advanced) is defined as the front side of the circular saw 10, and the opposite side thereof is defined as the rear side of the circular saw 10. In addition, at this time, the side located in the vertically upward direction is defined as the upper side of the circular saw 10, and the opposite side thereto is defined as the lower side of the circular saw 10. Moreover, a left-right direction is defined as the direction orthogonal to the front-rear direction and the up-down direction. The right side of the circular saw 10 in the left-right direction is defined as the right side when viewing the circular saw 10 from the rear side to the front side, and the opposite side thereto is defined as the left side of the circular saw 10.

As shown in FIG. 1, the circular saw 10 comprises a base 20 and a main-body portion 30. The base 20 has a substantially rectangular outer shape. The longitudinal direction of the base 20 is the front-rear direction. The base 20 has a flat lower surface, which is abutted against the workpiece when the workpiece is being cut.

As shown in FIG. 1, the main-body portion 30 is principally disposed upward of the base 20. As shown in FIGS. 1-4, the main-body portion 30 comprises a motor housing 11, a gear housing 12, a first handle 50, a second handle 60, an electric motor 41, the circular-saw blade 35, a fixed cover 33, and a movable cover 34.

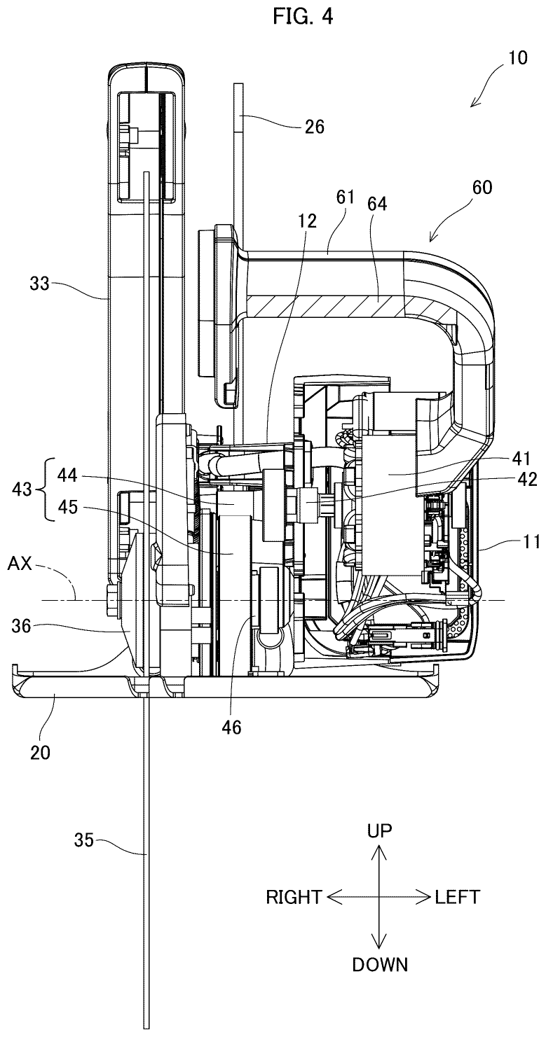

A portion of the circular-saw blade 35 passes through a through hole (slot) 21 in the base 20 and protrudes downward through (below) the base. The circular-saw blade 35 may be a tipped saw blade (e.g., carbide-tipped, cermet-tipped, diamond-tipped, etc.) and has a substantially circular shape. The circular-saw blade 35 is configured to be rotated about rotational axis AX, which extends in the left-right direction, as the center by rotational driving power provided (output) by the electric motor 41 (see FIG. 4). The fixed cover 33 covers an upper-side portion of the circular-saw blade 35 and has an arcuate shape. The movable cover 34 covers a portion of the circular-saw blade 35 that is downward of the fixed cover 33. The movable cover 34 is configured to be retractable along an outer-circumferential edge portion of the circular-saw blade 35 and is normally biased toward the location shown in FIG. 1 by a biasing member (not shown). When the circular saw 10 is in use, the movable cover 34 is pressed against the workpiece and retracts rearward, and thereby, the portion of the circular-saw blade 35 that is located downward of the base 20 is exposed.

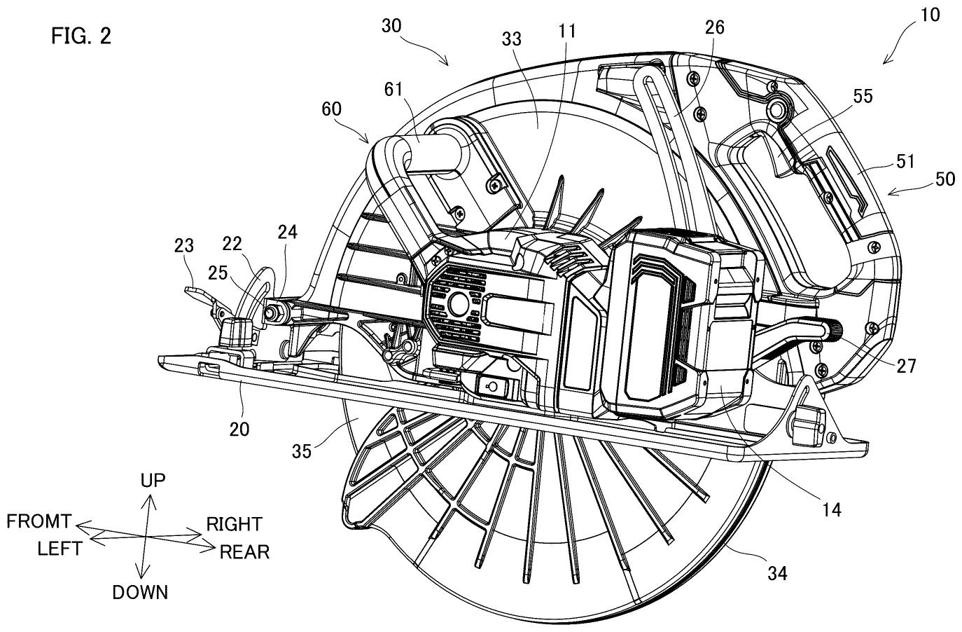

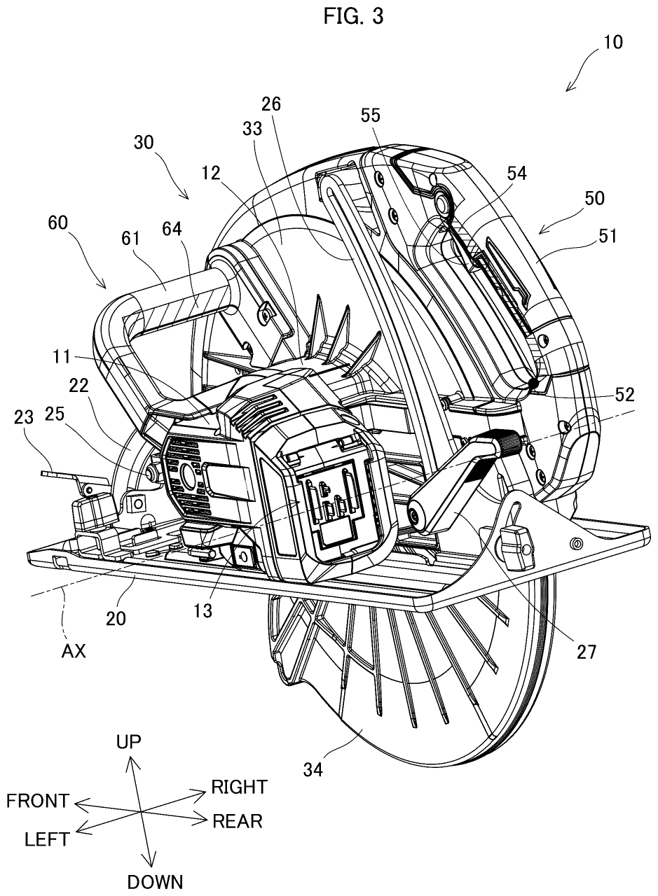

As shown in FIGS. 2 and 3, the motor housing 11 is disposed on the left side of the fixed cover 33. The electric motor 41, which is for providing rotational driving power to the circular-saw blade 35, is housed in the interior of the motor housing 11. A battery-mounting part 13 (see FIG. 3) is formed on a rear-end portion of the motor housing 11 and is configured to detachably mount a battery 14 (see FIG. 2), which supplies electric power to the electric motor 41. The battery 14 may be, e.g., a known rechargeable battery pack or battery cartridge that contains, e.g., lithium-ion battery cells or solid state batteries. The battery-mounting part 13 comprises electrical terminals for electrically connecting to the battery 14, and guide grooves that mate with convex portions (slide rails) of the battery. In the present embodiment, the battery-mounting part 13 is configured such that the battery 14 is mountable by sliding the battery 14 from upward to downward along the guide grooves. As shown in FIG. 2, by mounting the battery 14 so that the longitudinal direction of the battery 14 coincides with the up-down direction, the center of gravity of the battery 14 can be positioned more toward the front side when the battery 14 is mounted as compared with other layouts.

As shown in FIG. 3, the gear housing 12 is disposed between the fixed cover 33 and the motor housing 11 in the left-right direction. A mechanical mechanism (e.g., a speed-reducing mechanism 43 and a spindle 46, etc., which are explained below) for transmitting the rotational driving power of the electric motor 41 to the circular-saw blade 35 is housed in the interior of the gear housing 12. As shown in FIG. 4, a motor shaft 42 of the electric motor 41 extends in the left-right direction, which also may be called the axial direction or rotational axis direction. In addition, downward of the motor shaft 42, the spindle 46 extends parallel to the motor shaft 42. The spindle 46 extends from the interior of the gear housing 12 toward the right side, passing through a right surface of the gear housing 12 and a left surface of the fixed cover 33, and the circular-saw blade 35 is mounted on the tip thereof using a fixture 36, such as an outer flange and a hex bolt. The circular-saw blade 35 extends orthogonally to the lower surface of the base 20.

As shown in FIG. 4, the motor shaft 42 is operably coupled to the spindle 46 via the speed-reducing mechanism 43. The speed-reducing mechanism 43 comprises a drive gear 44, which is mounted around the motor shaft 42, and a driven gear 45, which is mounted around the spindle 46. The speed-reducing mechanism 43 reduces the rotational driving speed of a rotor of the electric motor 41 by a speed ratio that is defined based on the gear ratio between the drive gear 44 and the driven gear 45 and transmits the rotational-driving power (at a rotational speed that is less than the rotational speed of the rotor but with a higher torque) to the spindle 46 and, in turn, to the circular-saw blade 35.

As shown in FIGS. 2 and 3, the first handle 50 is formed as a loop-shaped handle. The first handle 50 extends in a tubular shape along the arcuate shape of the fixed cover 33 such that a gap (grip space) is formed between the fixed cover 33 and the first handle 50 along an upper-end portion on the rear side of the fixed cover 33. As a result, a first grip part 51, which can be gripped by inserting fingers into the grip space, is formed on the first handle 50. The first grip part 51 is a portion that extends in a circular-tube shape with a substantially constant diameter and is intended to be gripped by the user's hand when using the circular saw 10. A switch lever 55 for starting and stopping the electric motor 41 is provided on a front-end portion on the upper side of the first grip part 51. Consequently, the user will grip the first grip part 51 with one hand (typically, the right hand) at a location that is offset on the upper side of the first grip part 51 such that a finger (typically, the index finger) can reach the switch lever 55.

As shown in FIGS. 2 and 3, the second handle 60 is disposed more forward than the first handle 50. In the present embodiment, the second handle 60 is formed as a loop-shaped handle. However, it may also be formed as a rod-shaped handle that extends linearly (straight) leftward from the left surface of the fixed cover 33. The second handle 60 extends in a tubular shape so as to span (extend) from a portion of the left surface of the fixed cover 33, which is more forward than the electric motor 41, to an upper-end portion on the front side of the motor housing 11. The portion of the second handle 60 that extends in the left-right direction with a substantially constant diameter functions as a second grip part 61, which is intended for the user to grip with one hand (typically, the left hand) when using the circular saw 10.

When using the circular saw 10, the user grips the first grip part 51 of the first handle 50 with one (typically, the right) hand and the second grip part 61 of the second handle 60 with the other (typically, the left) hand and lifts the circular saw 10, and when the user presses the switch lever 55, the circular-saw blade 35 is rotated by the rotational driving power of the electric motor 41. In this state, the user abuts the lower surface of the base 20 (the portion more forward than the circular-saw blade 35) against the workpiece, and moves the circular saw 10 forward by sliding the base 20 along the surface of the workpiece. As a result, the cutting of the workpiece by the circular-saw blade 35, which protrudes downward beyond (below) the lower surface of the base 20, progresses in the direction that the circular saw 10 moves.

As shown in FIGS. 1 and 2, an angular plate 22 and a fixing lever 23 are mounted on the front-end portion. A bracket 24, which has a two-prong shape, is mounted on a rear surface of the angular plate 22. As shown in FIG. 1, a pivot shaft 25 is supported by (in) the bracket 24 in the state in which the pivot shaft 25 passes through the two prongs of the bracket 24 and through the front-end portion of the fixed cover 33, which is disposed between the two prongs of the bracket 24. According to such a configuration, the front side of the main-body portion 30 is supported by the pivot shaft 25 so as to be pivotable relative to the base 20 about the pivot shaft 25 to change the cutting depth of the circular-saw blade 35.

In this regard, the rear side of the main-body portion 30 is supported by a depth guide 26. The pivot location (i.e., the cutting depth) of the main-body portion 30 (the circular-saw blade 35) relative to the base 20 is adjustable by the depth guide 26 and a fixing lever 27. That kind of structure is well known, and therefore an explanation will be omitted here.

Moreover, the main-body portion 30 (the circular-saw blade 35) is also configured to be tiltable relative to the base 20 about a tilt axis, which extends in the front-rear direction. According to this configuration, the workpiece can be cut on a diagonal; i.e. bevel cuts can be performed. Such a tilting operation is implemented by using the angular plate 22 and the fixing lever 23. Because structures for the tilting (bevel cuts), in which the angular plate 22 is used, are well known, an explanation thereof will be omitted.

In the circular saw 10 described above, a circular-saw blade having a diameter of 300 mm or more and 460 mm or less is used as the circular-saw blade 35. According to this configuration, the radius of curvature of the circular-saw blade 35 is large compared with known battery-type circular saws equipped with a smaller-diameter (e.g., a diameter of 125 mm) circular-saw blade. Accordingly, even if the workpiece has a large cross section, the workpiece can be cut efficiently. The diameter of the circular-saw blade 35 may be 360 mm or more and 460 mm or less. If configured in this manner, the cutting efficiency can be further improved. A circular-saw blade of 415 mm is disclosed as a specific example in the present embodiment.

Moreover, the circular saw 10 may be configured so that the circular-saw blade 35 rotates at a circumferential speed of 25.0 m/s or more under a load (i.e. while the circular saw 10 is cutting a workpiece). According to this configuration, even if the workpiece has a large cross section, cutting can be efficiently performed at a sufficient circumferential speed. The circumferential speed under a load may be 28.0 m/s or more. If configured in this manner, the cutting efficiency can be further improved. A circumferential speed of 29.7 m/s under a load is disclosed as a specific example in the present embodiment.

Moreover, the circular saw 10 may be configured so that the circular-saw blade 35 rotates at a circumferential speed of 70.0 m/s or less under no-load (i.e. the circular-saw blade 35 is rotating freely while not cutting a workpiece). According to this configuration, the difference between the circumferential speeds of the circular-saw blade 35 under no-load and under a load can be made relatively small. Accordingly, the behavior of the circular saw 10 when starting to cut the workpiece is stable. As a result, the user's experience can be improved and the cut surface of the workpiece can be made flatter. The circumferential speed under no-load may be 50.0 m/s or less. If configured in this manner, the difference between the circumferential speeds of the circular-saw blade 35 under no-load and under a load can be made even smaller. A circumferential speed of 45.6 m/s under no-load is disclosed as a specific example in the present embodiment.

Moreover, the circular saw 10 may be configured to rotate so that the force at the blade edge of the circular-saw blade 35 under a load is 20.0 N or more. According to this configuration, even if the workpiece has a large (thick) cross section, the workpiece can be cut efficiently because a sufficient force acts on the workpiece. The force at the blade edge of the circular-saw blade 35 under a load may be 30.0 N or more. According to this configuration, the workpiece can be cut more efficiently. The force of the blade edge under load of 40.5 N is disclosed as a specific example in the present embodiment.

Moreover, a battery having a rated voltage of 18 V or more and 80 V or less may be used as the battery 14. According to this configuration, even if the workpiece has a large (thick) cross section, the workpiece can be cut efficiently owing to sufficient battery power output. The rated voltage of the battery 14 may be, e.g., from 24-40 V, such as 36 V. If configured in this manner, the circular saw 10 can be designed to be, with satisfactory balance, both compact (e.g., lightweight) and capable of a high power output.

Moreover, the speed-reduction ratio of the speed-reducing mechanism 43 may be set at 7 or more. According to this configuration, even if the workpiece has a large (thick) cross section, the workpiece can be cut efficiently because the circular saw 10 generates sufficient torque.

Various illustrative features will be explained below regarding the layout of the circular saw 10. The explanation below makes reference to features in the state in which the cutting depth of the circular-saw blade 35 is set to a maximum value (maximum depth) by the depth guide 26, and the circular-saw blade 35, when viewed in the front-rear direction, is set by the angular plate 22 to be parallel to the vertical direction (i.e. the circular-saw blade 35 is perpendicular to the base 20). However, the circular saw 10 may be configured so that the various features explained below also apply when the cutting depth of the circular-saw blade 35 is set to any arbitrary value between a minimum value (minimum depth) and the maximum value (maximum depth), and when the circular-saw blade 35, when viewed in the front-rear direction, is angled at any arbitrary angle (bevel angle) relative to the vertical direction. Alternatively, the circular saw 10 may be configured so that at least some of the various features explained below apply when the cutting depth of the circular-saw blade 35 is set to a specific value between the minimum value and the maximum value, and/or when the circular-saw blade 35, when viewed in the front-rear direction, is angled at a specific angle relative to the vertical direction.

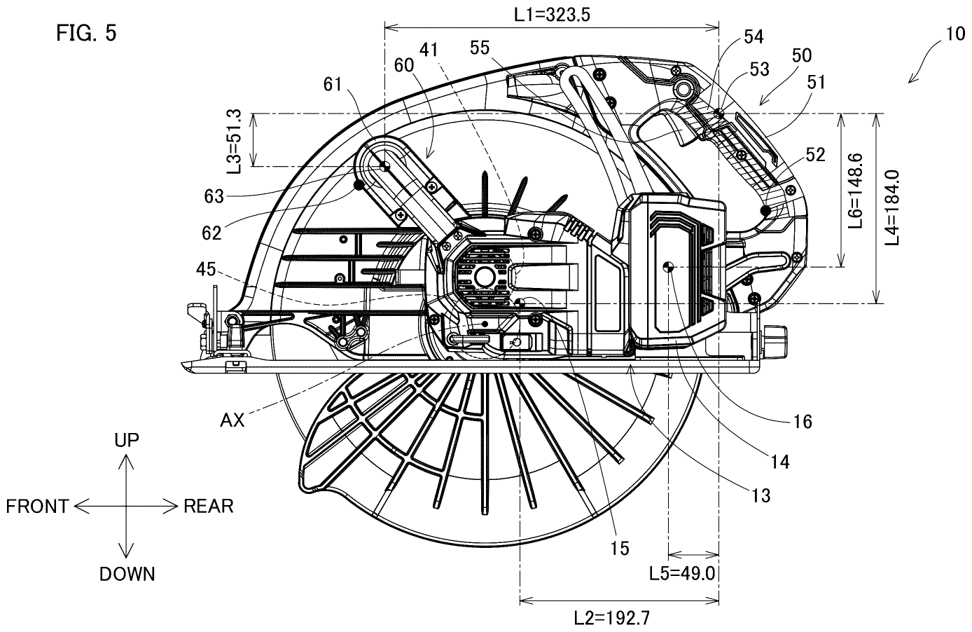

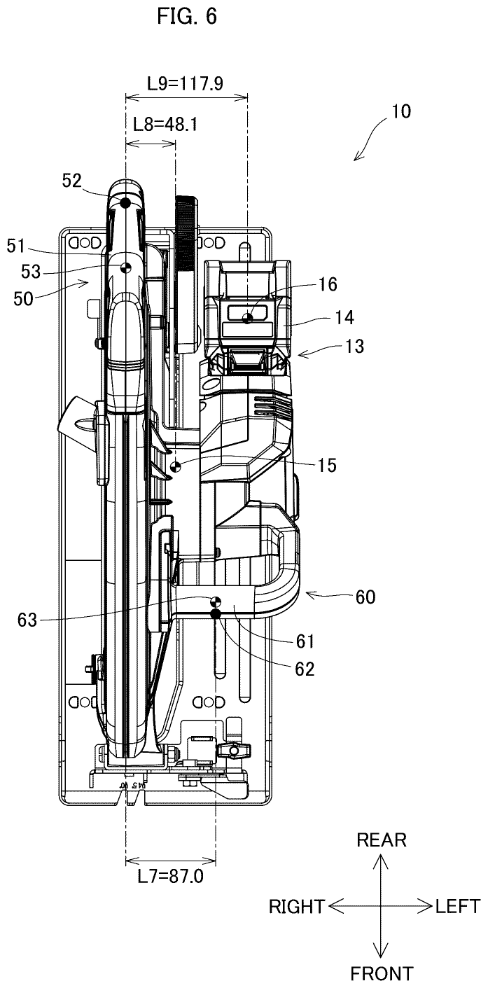

In the present embodiment, as shown in FIGS. 5 and 6, in the state in which the battery 14 is mounted on the battery-mounting part 13, the battery 14 is located in the front-rear direction between a front-side end portion 52 of the first grip part 51 of the first handle 50 and a front-side end portion 62 of the second grip part 61 of the second handle 60. Here, the front-side end portion 52 is the portion of a first half area 54 (indicated by hatching in FIG. 3) that is located most rearward. The first half area 54 is the area (the half of the outer-circumferential surface of the tubular body that is on the side proximate to rotational axis AX) of the half portion, in the circumferential direction, of the first grip part 51—which is a tubular body having a substantially constant diameter—that faces toward rotational axis AX of the circular-saw blade 35. In FIG. 3, only the left-side half of the first half area 54 can be seen. In addition, the front-side end portion 62 is the forwardmost portion of the second half area 64 (indicated by hatching in FIG. 3). The second half area 64 is the area of the half portion, in the circumferential direction, of the second grip part 61—which is a tubular body having a substantially constant diameter—that faces toward rotational axis AX of the circular-saw blade 35 (the half of the outer-circumferential surface of the tubular body that is on the side proximate to rotational axis AX). In FIG. 3, only a rear-side half of the second half area 64 can be seen.

If the diameter of the circular-saw blade 35 is made large as in the present embodiment, in addition to increasing the weight of the circular-saw blade 35, the battery 14, which is a heavy object, would need to have a higher power output. Consequently, in embodiments in which an arrangement identical to that of known circular saws that use a small-diameter circular-saw blade were to be adopted, then the weight balance would be poor when the user grips the first grip part 51 and the second grip part 61 and holds the circular saw 10. However, according to the arrangement described above, because the battery 14, which is a heavy object, is located between the front-side end portion 52 of the first grip part 51 and the front-side end portion 62 of the second grip part 61 (i.e., between the most rearward portion of the first grip part 51 and the most forward portion of the second grip part 61, which are the portions intended to be gripped by the user's hands), the weight balance is improved when the user grips the first grip part 51 and the second grip part 61 and holds the circular saw 10, even if the diameter of the circular-saw blade 35 is made large. Accordingly, the user can hold the circular saw 10 stably with a smaller force.

Moreover, in the present embodiment, as shown in FIG. 5, the center of gravity 15 of the circular saw 10, in the state in which the battery 14 has been mounted on the battery-mounting part 13 (i.e. the center of gravity in the state in which the battery 14 is mounted), is located downward of the end portion at the lower side of the first grip part 51 and the end portion at the lower side of the second grip part 61 in the up-down direction. By using such an arrangement, the weight balance is also improved for the user when the user grips the first grip part 51 and the second grip part 61 and holds the circular saw 10.

Moreover, in the present embodiment, as shown in FIG. 5, the center of gravity 16 of the battery 14, which is a heavy object, in the state in which the battery 14 is mounted on the battery-mounting part 13, is located downward of the end portion at the lower side of the first grip part 51 and the end portion at the lower side of the second grip part 61 in the up-down direction. By using this kind of arrangement, the weight balance is improved for the user when the user grips the first grip part 51 and the second grip part 61 and holds the circular saw 10.

Moreover, in the present embodiment, the first grip part 51, the second grip part 61, the center of gravity 15 of the circular saw 10, and the center of gravity 16 of the battery 14 are disposed to satisfy the conditions explained below. Specifically, first, as shown in FIGS. 5 and 6, a first center point 53 is defined as the center point of an area of the first grip part 51 at which the user actually grips the first grip part 51. In addition, a second center point 63 is defined as the center point of the second grip part 61. In actuality, when gripping the first grip part 51, the user grips the first grip part 51 at a location at which a finger of the hand gripping the first grip part 51 reaches the switch lever 55 (that is, at a location of the first grip part 51 that is in the vicinity of the end portion at the front side of the first grip part 51). The first center point 53 is a center point that is determined by focusing on only the area at which the user actually grips the first grip part 51 at that time.

Moreover, as shown in FIG. 5, distance L1 is defined as the distance between the first center point 53 and the second center point 63 in the front-rear direction, and distance L2 is defined as the distance between the first center point 53 and the center of gravity 15 of the circular saw 10 in the front-rear direction. Moreover, as shown in FIG. 5, distance L3 is defined as the distance between the first center point 53 and the second center point 63 in the up-down direction, and distance L4 is defined as the distance between the first center point 53 and the center of gravity 15 of the circular saw 10 in the up-down direction.

Moreover, as shown in FIG. 5, distance L5 is defined as the distance between the first center point 53 and the center of gravity 16 of the battery 14 in the front-rear direction, and distance L6 is defined as the distance between the first center point 53 and the center of gravity 16 of the battery 14 in the up-down direction.

Moreover, as shown in FIG. 6, distance L7 is defined as the distance between the first center point 53 and the second center point 63 in the left-right direction (i.e., the direction in which rotational axis AX of the circular-saw blade 35 extends), distance L8 is defined as the distance between the first center point 53 and the center of gravity 15 of the circular saw 10 in the left-right direction, and distance L9 is defined as the distance between the first center point 53 and the center of gravity 16 of the battery 14 in the left-right direction.

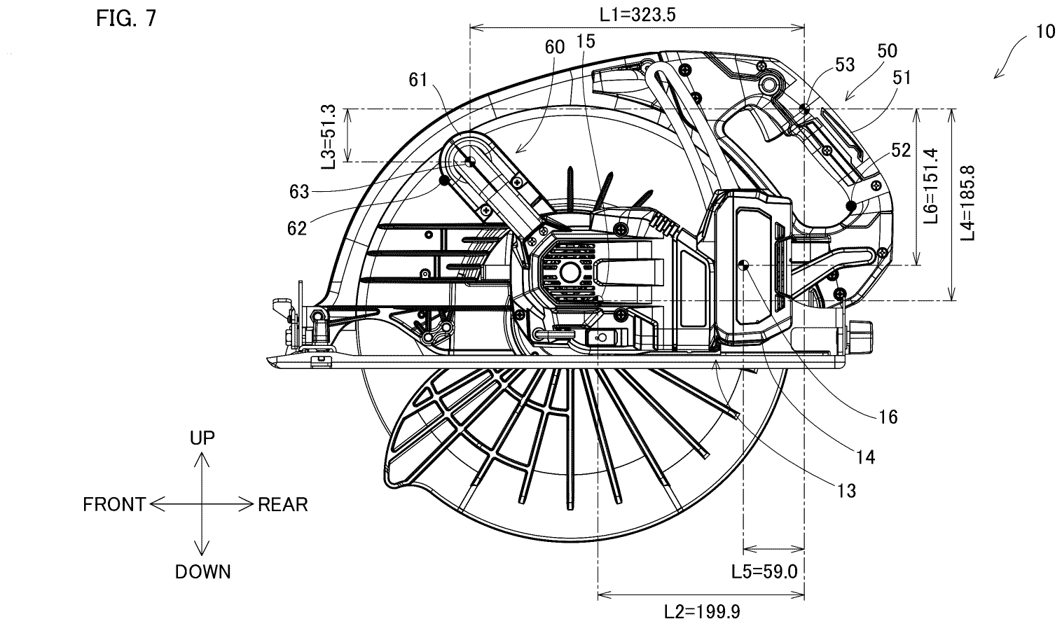

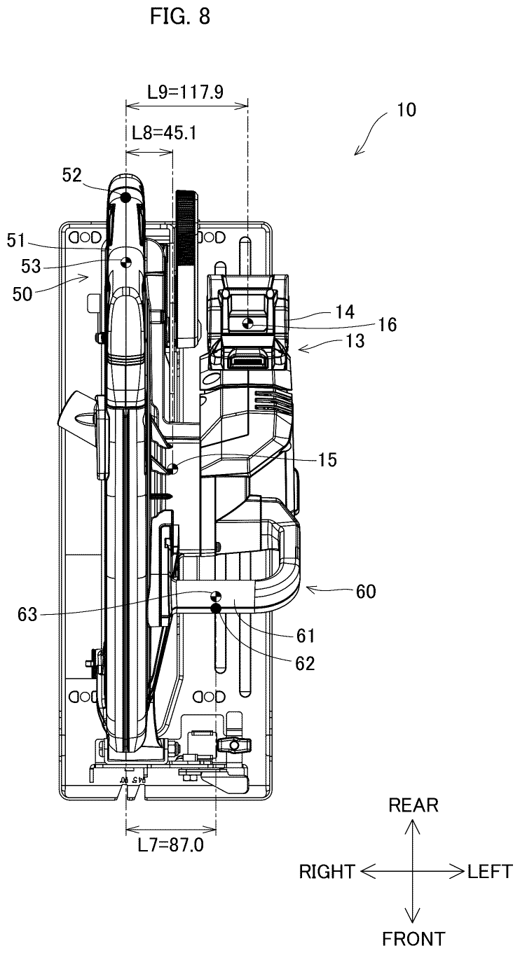

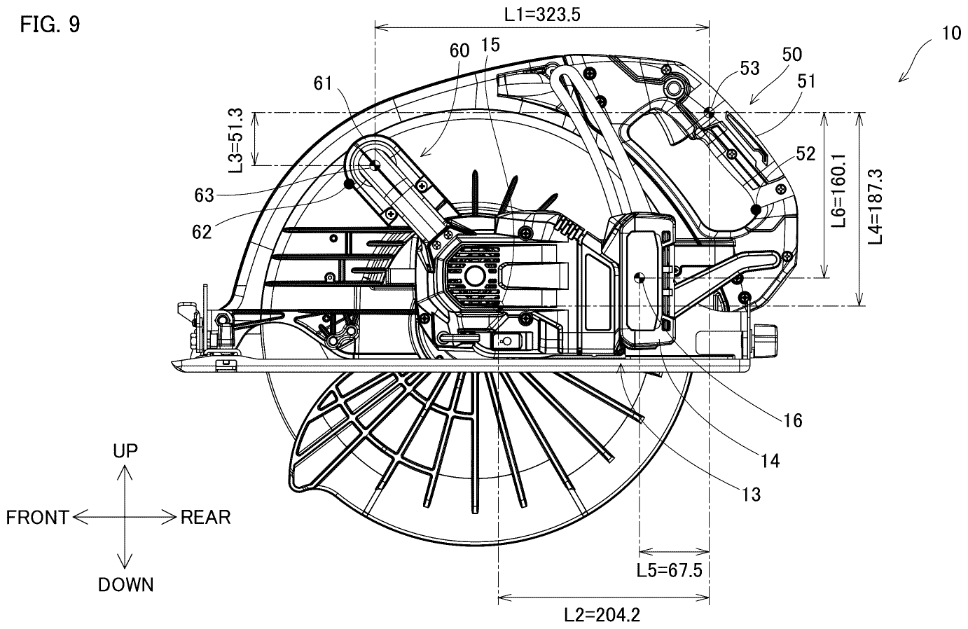

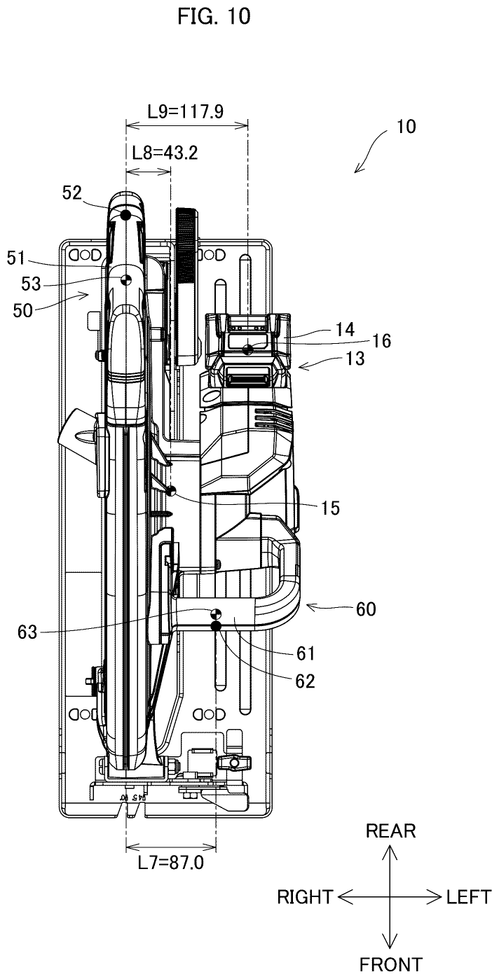

At this time, a first example, a second example, and a third example of design dimensions for distances L1-L9 are indicated in FIG. 5 and FIG. 6, FIG. 7 and FIG. 8, and FIG. 9 and FIG. 10, respectively. The unit of the dimensions depicted is millimeters (mm). Specifically, in the first example, distance L1 is 323.5 mm, distance L2 is 192.7 mm, distance L3 is 51.3 mm, distance L4 is 184.0 mm, distance L5 is 49.0 mm, distance L6 is 148.6 mm, distance L7 is 87.0 mm, distance L8 is 48.1 mm, and distance L9 is 117.9 mm. In the second example, distance L1 is 323.5 mm, distance L2 is 199.9 mm, distance L3 is 51.3 mm, distance L4 is 185.8 mm, distance L5 is 59.0 mm, distance L6 is 151.4 mm, distance L7 is 87.0 mm, distance L8 is 45.1 mm, and distance L9 is 117.9 mm. In the third example, distance L1 is 323.5 mm, distance L2 is 204.2 mm, distance L3 is 51.3 mm, distance L4 is 187.3 mm, distance L5 is 67.5 mm, distance L6 is 160.1 mm, distance L7 is 87.0 mm, distance L8 is 43.2 mm, and distance L9 is 117.9 mm. In the first example, the capacity of the battery 14 is 8 Ah; in the second example, the capacity of the battery 14 is 5 Ah; and in the third example, the capacity of the battery 14 is 4 Ah.

In all the first through third examples, distances L1-L9 satisfy the following equations (1)-(4).

$$0.5 \leq L 2 / L 1 \leq 0. 7 \qquad ( 1 )$$

$$3.4 \leq L 4 / L 3 \leq 3.8 \qquad ( 2 )$$

$$0.1 \leq L 5 / L 1 \leq 0. 3 \qquad ( 3 )$$

$$2.8 \leq L 6 / L 3 \leq 3.2 \qquad ( 4 )$$

$$0.4 \leq L 8 / L 7 \leq 0.7 \qquad ( 5 )$$

$$1.3 \leq L 9 / L 7 \leq 1.5 \qquad ( 6 )$$

In embodiments in which such conditions are satisfied, the weight balance of the circular saw is improved for the user when the user grips the first grip part 51 and the second grip part 61 and holds the circular saw 10. It is noted that the layout of the circular saw 10 may be determined to satisfy at least one of the above-mentioned equations (1)-(6).

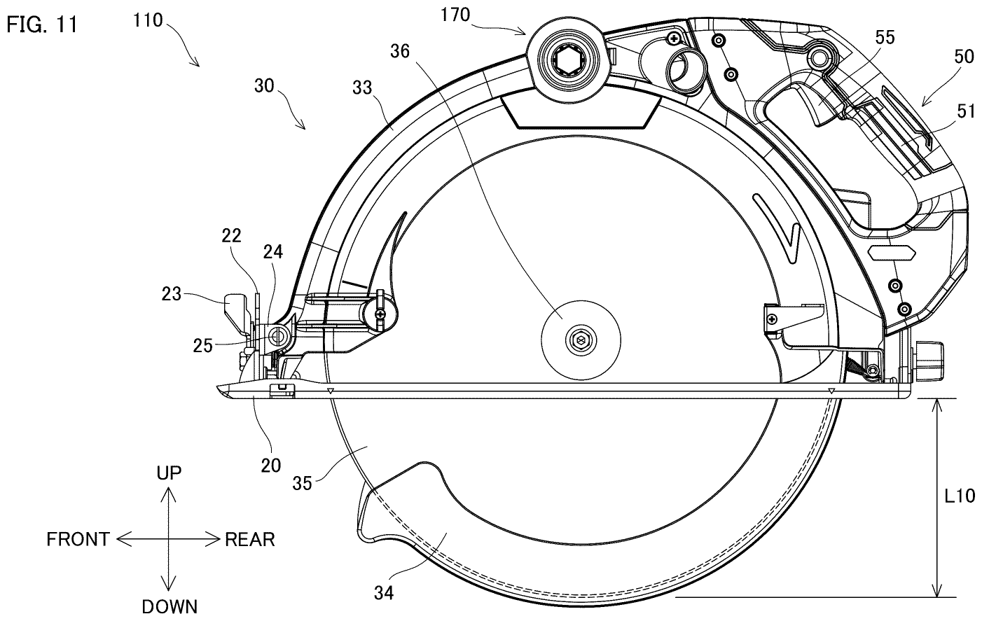

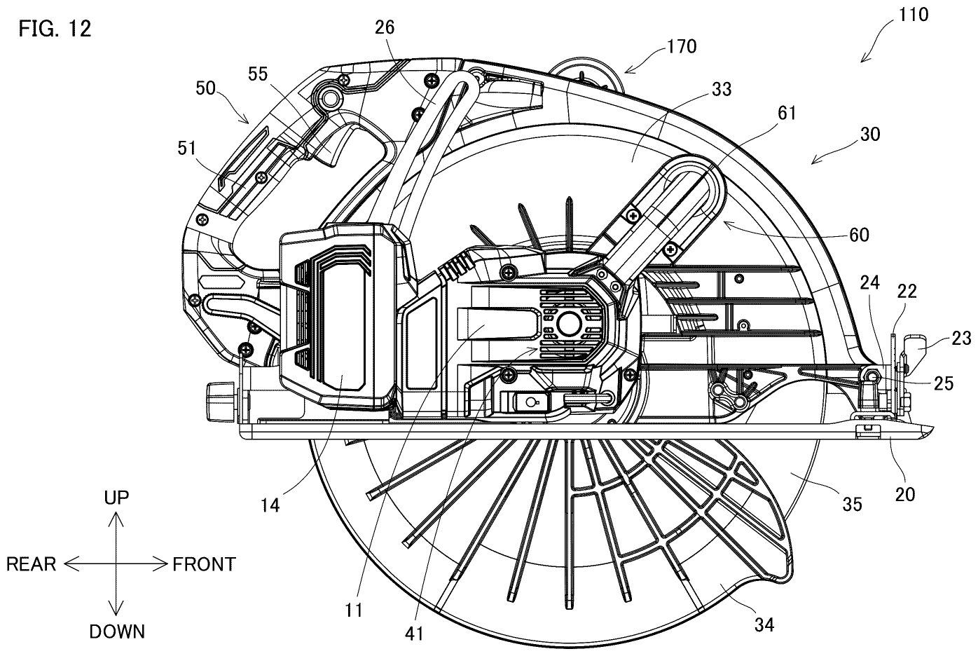

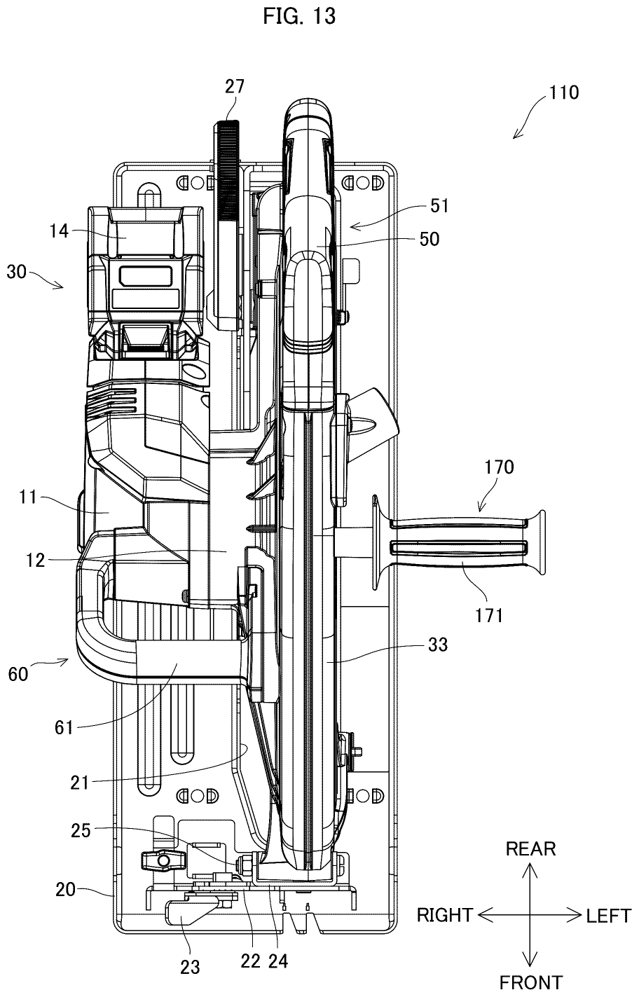

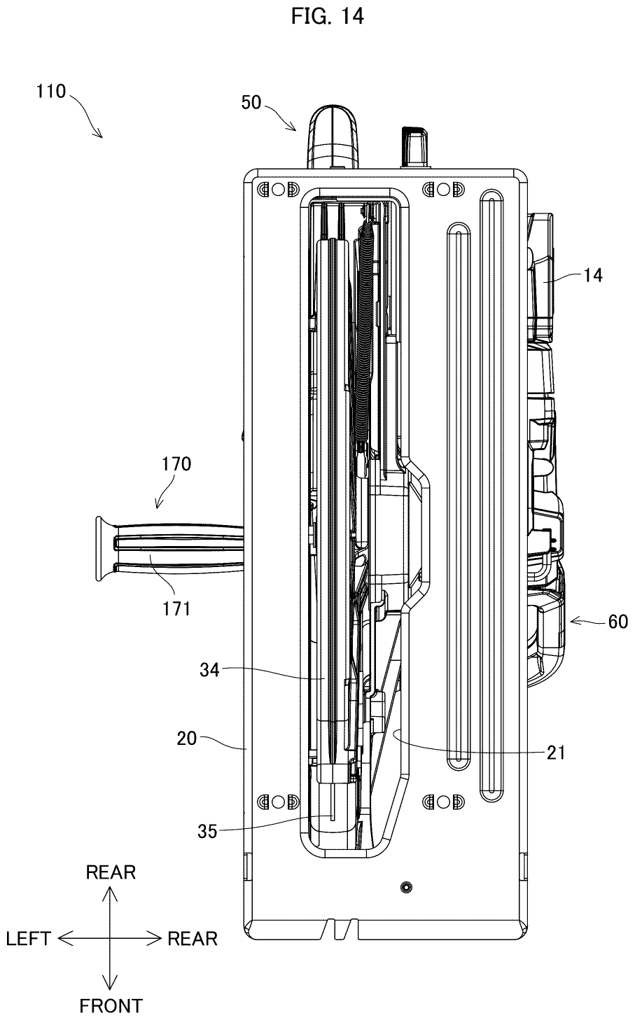

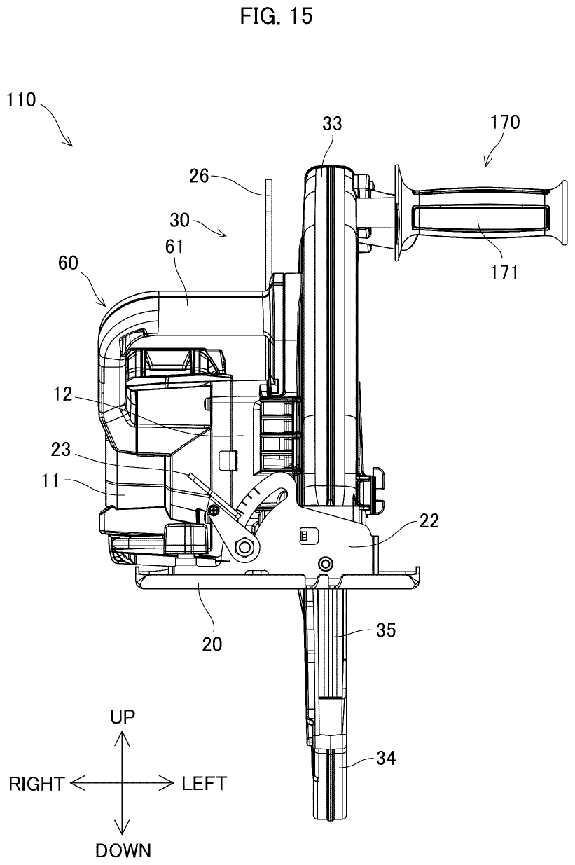

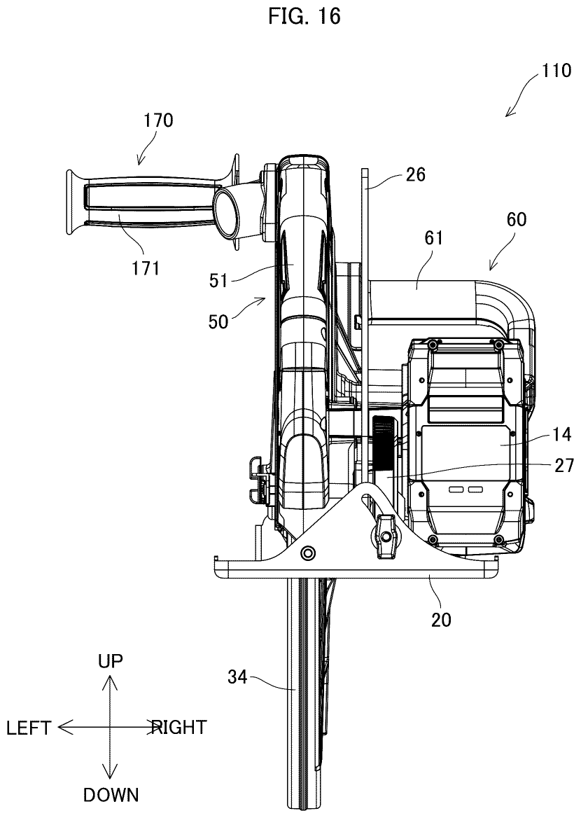

A second embodiment is described below with reference to FIGS. 11-17, in which only points that differ from those in the first embodiment are explained. As is clear from FIGS. 12 and 13, in a circular saw 110 according to the second embodiment, the circular-saw blade 35 is located on the left side relative to the electric motor 41 (the motor housing 11) in contrast to the circular saw 10 (see FIG. 3), in which the circular-saw blade 35 is located on the right side relative to the electric motor 41. According to this layout, when a user stands to the left of the circular saw 110 and uses the circular saw 110, the motor housing 11 is not positioned in the user's line of sight toward the circular-saw blade 35. In addition, the circular-saw blade 35 is located closer to the user in the left-right direction. Accordingly, when the user is cutting using the circular saw 110, the visibility of the circular-saw blade 35, which is visible between a front portion of the fixed cover 33 and a front portion of the base 20, can be improved, particularly at the site where the circular-saw blade 35 intersects the marking line on the workpiece.

As shown in FIGS. 11-16, the circular saw 110 comprises a third handle 170 in addition to the first handle 50 and the second handle 60. The shape of the first handle 50 and the location of the first handle 50 relative to the base 20 are the same as those in the first embodiment described above. That is, the first handle 50 is located at the rear side and on an end portion at the upper side of the fixed cover 33, and the first grip part 51 of the first handle 50 is located, at least partially, more rearward than the circular-saw blade 35.

The second handle 60 comprises a second grip part 61, the same as in the first embodiment. The second handle 60 extends in a tubular shape so as to span (extend) between a portion of a right surface of the fixed cover 33, which is more forward than the electric motor 41, and the upper-end portion on the front side of the motor housing 11. That is, in contrast to the circular saw 10 according to the first embodiment, the second handle 60 is located on the right side relative to the circular-saw blade 35. In addition, the second grip part 61 of the second handle 60 is located forward of the electric motor 41 (the motor housing 11). This point is the same as in the first embodiment.

In the present embodiment, the third handle 170 formed as a rod-shaped handle. The third handle 170 is located leftward of the circular-saw blade 35. In other words, the third handle 170 is located on the opposite side of the second handle 60 relative to the circular-saw blade 35. As shown in FIGS. 11, 13, and 15, the third handle 170 extends linearly (straight) leftward from a left-side surface that is located at the upper-end portion of the fixed cover 33. In the present embodiment, the third handle 170 is located at substantially the same location as that of the electric motor 41 in the front-rear direction. The third handle 170 comprises a third grip part 171, which can be gripped by the user. In the present second embodiment, a base end (the right end) of the third handle 170 is screwed into a screw hole formed in the fixed cover 33. That is, the third handle 170 is removable. However, the third handle 170 may be coupled to the fixed cover 33 in a non-removable manner. In addition, the third handle 170 may have any arbitrary form, e.g., instead of having the form of a rod-shaped handle, the third handle 170 may have the form of a loop handle, like the first handle 50 or the second handle 60.

According to the circular saw 110 thus configured, the user may choose to use the different handles that are to be gripped in accordance with the user's working posture. For example, the user may stand rightward of the circular saw 110 and grip the first grip part 51 with one hand and the second grip part 61 with the other hand to use the circular saw 110. Alternatively, the user may stand leftward of the circular saw 110 and grip the first grip part 51 with one hand and the third grip part 171 with the other hand to use the circular saw 110. Moreover, according to the circular saw 110, the spacing between the first grip part 51 and the second grip part 61 in the front-rear direction can be made larger by locating the second grip part 61 forward of the electric motor 41. Consequently, the circular saw 110 can be stably held when the user grips the first grip part 51 and the second grip part 61 and uses the circular saw 110.

Moreover, in the circular saw 110, the circular-saw blade 35 is orthogonal to the base 20 and, in the state in which a protrusion distance by which the circular-saw blade 35 protrudes from the base 20 becomes the maximum, protrusion distance L10 (see FIG. 11), by which the circular-saw blade 35 protrudes downward beyond (below) the base 20, is 100 mm or more. According to this configuration, a workpiece having a larger thickness can be cut compared with known circular saws. Protrusion distance L10 may be 150 mm or more. If configured in this manner, a workpiece having a larger thickness can be cut. A protrusion distance of 158 mm is disclosed as a specific example in the present embodiment.

Moreover, in the circular saw 110, when the torque of the spindle 46 is 5 N/m, the circumferential speed of the blade edge of the circular-saw blade 35 is 32.4 m/s. At this time, a value resulting from multiplying the circumferential speed of the blade edge of the circular-saw blade 35 by the diameter of the circular-saw blade 35 (referred to below as a “multiplication product”) is 0.415 m (=415 mm)×32.4 m/s=13.4 m²/s. The larger the diameter of the circular-saw blade 35, the lower the transmission loss of the motive power needed to approach linear motion becomes, and thereby cutting efficiency increases; therefore, if this multiplication product is 6.0 m²/s, then the workpiece can be more efficiently cut compared with known circular saws. This multiplication product may be 10.0 m²/s or more. If configured in this manner, the cutting efficiency can be further increased.

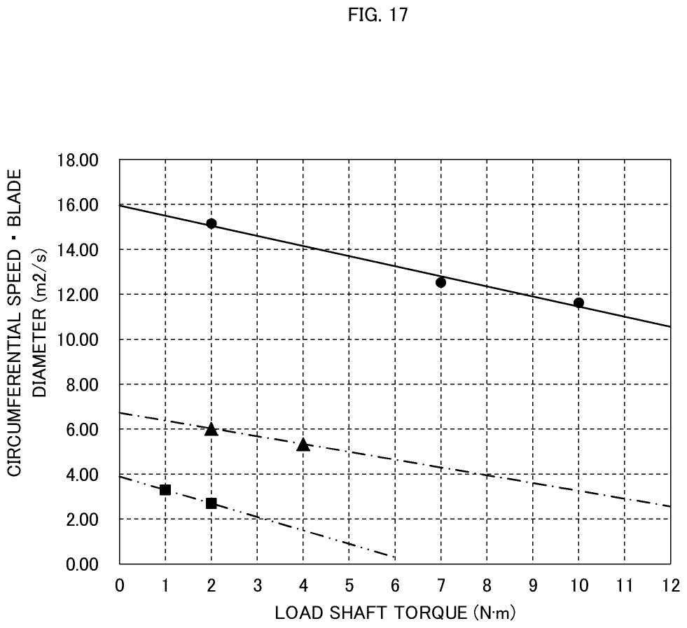

FIG. 17 shows the difference in multiplication products for the circular saw 110 and known circular saws. The straight line depicted by a solid line corresponds to the circular saw 110 according to the present embodiment (the rated output of the battery 14 is 36 V, and the diameter of the circular-saw blade 35 is 415 mm), the multiplication products are plotted for examples in which the torques of the spindle 46 are 2, 7, and 10 N/m, and the result of computing a straight-line approximation thereof is shown. The straight line depicted by a chain line corresponds to a known circular saw (the rated output of the battery is 36 V, and the diameter of the circular-saw blade 35 is 165 mm), the multiplication products are plotted for examples in which the torques of the spindle are 2 and 4 N/m, and the result of computing a straight-line approximation thereof is shown. The straight line depicted by a chain, double-dashed line corresponds to a known circular saw that incorporates the techniques disclosed in Patent Document 1 (the rated output of the battery is 18 V, and the diameter of the circular-saw blade 35 is 125 mm), the multiplication products are plotted for examples in which the torques of the spindle are 1 and 2 N/m, and the result of computing a straight-line approximation thereof is shown. Because circular saws are typically used in a state in which the torque of the spindle is approximately 4-7 N/m, if the multiplication product when the torque of the spindle 46 is 5 N/m is employed as an index value, then cutting efficiency can be satisfactorily evaluated.

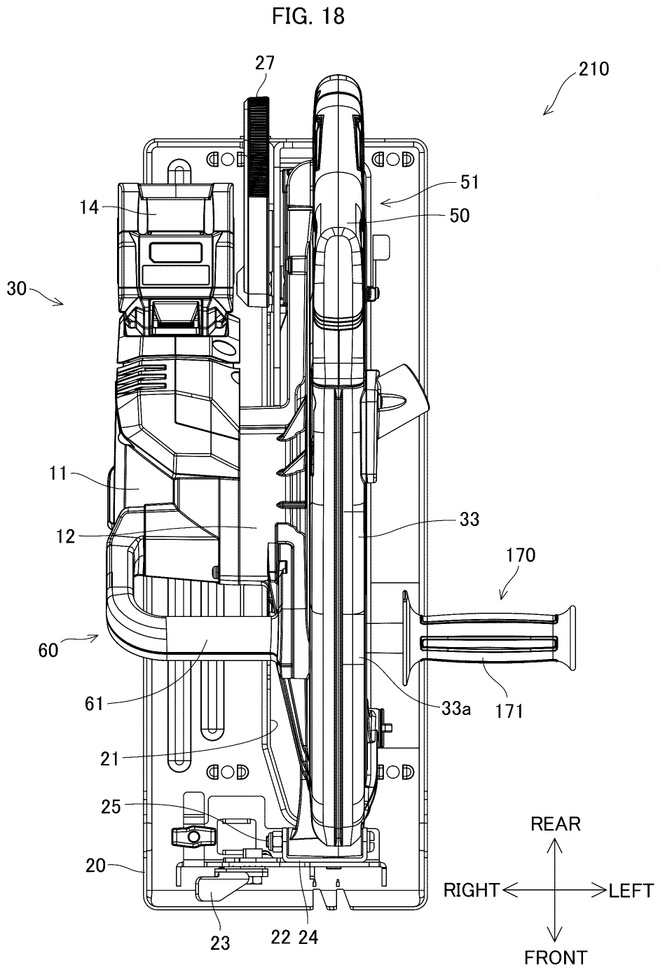

A third embodiment is described below with reference to FIG. 18, in which only points that differ from those in the second embodiment are explained. A circular saw 210 according to the third embodiment differs from the second embodiment in only the location of the third handle 170. Specifically, the third handle 170 is mounted on the fixed cover 33 at a location forward of the electric motor 41 (the motor housing 11). The fixed cover 33 comprises a protruding portion 33a, which protrudes upward, at the mount position of the third handle 170. By mounting the third handle 170 on the protruding portion 33a, the third handle 170 can be provided outward of the blade edge of the circular-saw blade 35, and thereby interference between the circular-saw blade 35 and the third handle 170 can be avoided. According to the present third embodiment, the spacing between the first grip part 51 and the third grip part 171 in the front-rear direction becomes even larger than in the second embodiment. Consequently, the circular saw 210 can be held even more stably when the user grips the first grip part 51 and the third grip part 171 and uses the circular saw 210.

Although a number of embodiments of the present teachings have been explained above, the embodiments described above are merely for aiding the understanding of the present invention and do not limit the scope of the present invention. Modifications and improvements may be made to the present teachings without departing from the gist thereof, and the present teachings encompass such equivalents. In addition, the structural elements described in the claims and the specification may be arbitrarily combined or omitted within a scope that can solve at least one technical problem and/or within a scope that exhibits at least one of the advantages and/or effects described above.

For example, the respective features of the specifications (diameter of the circular-saw blade, circumferential speed of the circular-saw blade, force of the blade edge of the circular-saw blade, rated voltage of the battery 14, speed-reduction ratio of the speed-reducing mechanism 43, etc.) of the circular saw 10 described above and the respective features of the various layouts of the circular saw 10 are separable from other features and can each be adopted individually.

Moreover, the specifications of the circular saw 10 described above are not limited to a portable circular saw and are applicable to a table-top circular saw or a sliding circular saw that uses a battery as an electric power supply.

The correspondence relationship between the component elements in the above-mentioned embodiments and the component elements of the present invention are as follows. However, the component elements in the embodiments are merely one example and do not limit the component elements of the present invention. The circular saw 10 is one example of a “circular saw.” The circular-saw blade 35 is one example of a “circular-saw blade.” The electric motor 41 is one example of an “electric motor.” The battery-mounting part 13 is one example of a “battery-mounting part.” The battery 14 is one example of a “battery.” The speed-reducing mechanism 43 is one example of a “speed-reducing mechanism.” The first handle 50 is one example of a “first handle.” The first grip part 51 is one example of a “first grip part.” The second handle 60 is one example of a “second handle.” The second grip part 61 is one example of a “second grip part.” The front-side end portion 52 is one example of an “end portion at the front side of a first grip part.” The front-side end portion 62 is one example of an “end portion at the front side of a second grip part.” The first center point 53 is one example of a “first center point.” The second center point 63 is one example of a “second center point.” The center of gravity 15 is one example of a “first center of gravity.” The spindle 46 is one example of a “final output shaft.”

### EXPLANATION OF THE REFERENCE NUMBERS

10 Portable circular saw
11 Motor housing
12 Gear housing
13 Battery-mounting part
14 Battery
15 Center of gravity of circular saw
16 Center of gravity of battery
20 Base
21 Through hole
22 Angular plate
23 Fixing lever
24 Bracket
25 Pivot
26 Depth guide
27 Fixing lever
30 Main-body portion
33 Fixed cover
33a Protruding portion
34 Movable cover
35 Circular-saw blade
36 Fixture
41 Electric motor
42 Motor shaft
43 Speed-reducing mechanism
44 Drive gear
45 Driven gear
46 Spindle
50 First handle
51 First grip part
52 Front-side end portion
53 First center point
54 First half area
55 Switch lever
60 Second handle
61 Second grip part
62 Front-side end portion
63 Second center point
64 Second half area
AX Rotational axis of circular-saw blade

1. A circular saw comprising:
a rotatable circular-saw blade;
an electric motor configured to generate rotational power for rotatably driving the circular-saw blade; and
a battery-mounting part configured to detachably mount a battery that supplies electric power to the electric motor;
wherein the circular-saw blade has a diameter of 300 mm or more and 460 mm or less.

2. The circular saw according to claim 1, wherein the circular saw is configured so that the circular-saw blade rotates at a circumferential speed of 70.0 m/s or less under no-load.

3. The circular saw according to claim 1, wherein the circular saw is configured so that the circular-saw blade rotates at a circumferential speed of 50.0 m/s or less under no-load.

4. The circular saw according to claim 1, wherein the circular saw is configured so that the circular-saw blade rotates at a circumferential speed of 25.0 m/s or more under a load.

5. The circular saw according to claim 1, wherein the circular saw is configured so that the circular-saw blade rotates at a circumferential speed of 28.0 m/s or more under a load.

6. The circular saw according to claim 1, wherein the circular saw is configured to rotate such that a force at a blade edge of the circular-saw blade under a load is 20.0 N or more.

7. The circular saw according to claim 6, wherein the circular saw is configured to rotate such that a force at a blade edge of the circular-saw blade under a load is 30.0 N or more.

8. The circular saw according to claim 1, comprising:
the battery;
wherein the rated voltage of the battery is 18 V or more and 80 V or less.

9. The circular saw according to claim 8, wherein:
the rated voltage of the battery is 36 V.

10. The circular saw according to claim 1, comprising:
a speed-reducing mechanism configured to transmit the rotational power generated by the electric motor at a reduced speed to the circular-saw blade;
wherein the speed-reducing mechanism has a speed-reduction ratio of 7 or more.

11. The circular saw according to claim 1, wherein:
the circular saw is a portable circular saw;
the portable circular saw comprises:
a first handle, which has a first grip part; and
a second handle, which has a second grip part and is disposed forward of the first handle when the direction in which cutting by the portable circular saw is advanced is defined as a front side, and the opposite side to the front side is defined as a rear side; and
the battery-mounting part is configured so that, when the battery is mounted on the battery-mounting part, the entire battery is located between an end portion at the front side of the first grip part and an end portion at the front side of the second grip part in a front-rear direction.

12. The circular saw according to claim 1, wherein:
the circular saw is a portable circular saw;
the portable circular saw comprises:
a first handle, which has a first grip part; and
a second handle, which has a second grip part and is disposed forward of the first handle when the direction in which cutting by the portable circular saw is advanced is defined as a front side, and the opposite side to the front side is defined as a rear side; and
the center of gravity of the circular saw, in the state in which the battery is mounted on the battery-mounting part, is located downward of an end portion at the lower side of the first grip part and an end portion at the lower side of the second grip part in an up-down direction in the posture of the portable circular saw during normal usage thereof.

13. The circular saw according to claim 1, wherein:
the circular saw is a portable circular saw;
the portable circular saw comprises:
a first handle, which has a first grip part;
a second handle, which has a second grip part and is disposed more forward than the first handle when a direction in which cutting by the portable circular saw is advanced is defined as a front side, and the opposite side to the front side is defined as a rear side; and
the battery; and
the center of gravity of the battery, in the state in which the battery is mounted on the battery-mounting part, is located downward of an end portion at the lower side of the first grip part and an end portion at the lower side of the second grip part in an up-down direction in the posture of the portable circular saw during normal usage thereof.

14. The circular saw according to claim 1, wherein:
the circular saw is a portable circular saw;
the portable circular saw comprises:
a first handle, which has a first grip part;
a second handle, which has a second grip part and is disposed forward of the first handle when the direction in which cutting by the portable circular saw is advanced is defined as a front side, and the opposite side to the front side is defined as the rear side;
L1 is defined as the distance in the front-rear direction between a first center point of the first grip part, which is the center point of an area where the user actually grips the first grip part, and a second center point, which is the center point of the second grip part;
L2 is defined as the distance in the front-rear direction between the first center point and a first center of gravity, which is the center of gravity of the circular saw in the state in which the battery is mounted on the battery-mounting part; and
the value of L2/L1 is 0.5 or more and 0.7 or less.

15. The circular saw according to claim 1, wherein:
the circular saw is a portable circular saw;
a base of the circular saw has a through hole through which the circular-saw blade passes during a cutting operation;
the side on which the electric motor is located relative to the base is defined as an upper side in an up-down direction;
the opposite side thereof in the up-down direction is defined as a lower side; and
in a maximum depth state in which the circular-saw blade is orthogonal to the base and the circular-saw blade protrudes through the through hole by a maximum amount in the up-down direction, a maximum distance from the base to the lowest circumferential edge of the circular-saw blade in the up-down direction is 100 mm or more.

16. The circular saw according to claim 15, wherein the maximum distance in the maximum depth state is 150 mm or more.

17. A circular saw comprising:
a rotatable circular-saw blade;
an electric motor configured to generate rotational power for rotatably driving the circular-saw blade; and
a rotatable final output shaft, on which the circular-saw blade is mounted and to which the rotational power of the electric motor is transmitted; and
a battery-mounting part configured to detachably mount a battery that supplies electric power to the electric motor;
wherein, in a state in which the torque of the final output shaft is 5 N/m, a multiplication product of the circumferential speed of a blade edge of the circular-saw blade and the diameter of the circular-saw blade is 6.0 m²/s or more.

18. The circular saw according to claim 17, wherein the multiplication product is 10.0 m²/s or more.

19. The circular saw according to claim 17, wherein:
the circular saw is a portable circular saw;
a base of the circular saw has a through hole through which the circular-saw blade passes during a cutting operation;
the side toward which the circular saw is advanced when the circular saw is cutting a workpiece is defined as a front side in a front-rear direction;
the opposite side thereof in the front-rear direction is defined as a rear side,
the side on which the electric motor is located relative to the base is defined as an upper side in an up-down direction;
the opposite side thereof in the up-down direction is defined as a lower side,
a direction orthogonal to the front-rear direction and the up-down direction is defined as a left-right direction;
the side when looking from the rear side toward the front side is defined as a right side in the left-right direction;
the opposite side thereof in the left-right direction is defined as a left side; and
the circular-saw blade is located on the left side relative to the electric motor.

20. The circular saw according to claim 19, further comprising:
a first handle, which has a first grip part that is located, at least partially, rearward of the circular-saw blade in the front-rear direction;
a second handle, which has a second grip part that is located forward of the electric motor in the front-rear direction and is located rightward of the circular-saw blade in the left-right direction; and
a third handle, which has a third grip part that is located leftward of the circular-saw blade in the left-right direction.
